(19) United States
(12) Patent Application Publication
(10) Pub. No.: US 2023/0314804 A1
(43) Pub. Date: Oct. 5, 2023

(54) POLARIZATION-RECYCLING WAVEGUIDED ILLUMINATION SYSTEM FOR MICRODISPLAY

(71) Applicant: Microsoft Technology Licensing, LLC, Redmond, WA (US)

(72) Inventors: Ishan CHATTERJEE, Seattle, WA (US); Poon Yarn CHEE, Sammamish, WA (US); Joel Steven KOLLIN, Seattle, WA (US); Fei CHEN, Woodinville, WA (US)

(21) Appl. No.: 17/710,910

(22) Filed: Mar. 31, 2022

(51) Int. Cl. G02B 27/01; F21V 8/00

(52) U.S. Cl. CPC G02B 27/0172; G02B 6/0035; G02B 6/005; G02B 2027/0178

(57) ABSTRACT

An illumination system for non-emissive polarization-sensitive microdisplays such as LCoS is implemented in a waveguide that guides illumination light from an unpolarized source to the microdisplay while simultaneously recycling light of the wrong polarization for the microdisplay to improve illumination efficiency. Polarization recycling may be performed at one or more of an input coupler that in-couples illumination light to the waveguide, the waveguide itself, or an output coupler that out-couples the illumination light from the waveguide to the microdisplay.

### BACKGROUND

Mixed-reality computing devices, such as head-mounted display (HMD) devices may be configured to display information to a user about virtual objects and/or real objects in a field of view. Liquid crystal on silicon (LCoS) microdisplays are commonly utilized in display engines in mixed-reality HMD devices because of their high resolution and compactness. LCoS microdisplays comprise polarized display panels that require single polarized illumination as they can only modulate one polarization of light. Using unpolarized illumination sources such as LEDs (light emitting diodes) does not necessarily result in halving illumination brightness as polarization recycling may be utilized to recover some light of the wrong polarization.

### SUMMARY

An illumination system adapted to provide illumination for non-emissive polarization-sensitive microdisplays such as LCoS is implemented in a waveguide that guides illumination light from an unpolarized source to the microdisplay while simultaneously recycling light of the wrong polarization for the microdisplay to improve illumination efficiency. Polarization recycling may be performed at one or more of an input coupler that in-couples LED illumination light to the waveguide, the waveguide itself, or an output coupler that out-couples the illumination light from the waveguide to the microdisplay.

In an exemplary polarization-recycling input coupler in a waveguided illumination system, a series of in-coupling reflectors are disposed in a waveguide on either side of a half-wave plate. The first (i.e., upstream) reflector is polarization sensitive and configured to selectively reflect incoming illumination light from an unpolarized source, in a first linear polarization that is correct for the microdisplay, into the waveguide. Illumination light in an orthogonal second linear polarization that is wrong for the microdisplay is transmitted by the upstream polarization-sensitive reflector. The transmitted illumination light is converted by a half-wave plate into an orthogonal polarization state and then reflected by the second (i.e., downstream) reflector into the waveguide. The waveguide thus propagates illumination light of a single polarization that is correct for the microdisplay (i.e., the polarization state of the illumination matches the polarization sensitivity of the microdisplay).

In an exemplary polarization-recycling waveguide in a waveguided illumination system, polarization-sensitive reflectors or externally-applied reflective coatings are continuously disposed along portions of the waveguide over which a quarter-wave plate and mirror are respectively disposed. The polarization-sensitive reflectors selectively reflect illumination light having the correct polarization for the microdisplay which then propagates along the waveguide. Light in the wrong polarization for the microdisplay is transmitted by the polarization-sensitive reflector and thus escapes the waveguide to the combination of quarter-wave plate and mirror. By making two passes through the quarter-wave plate, the escaping illumination light reenters the waveguide in an orthogonal polarization. Each bounce of light at various spatial locations in the waveguide will convert some percentage of illumination to the correct polarization for the microdisplay.

In a first exemplary embodiment of a polarization-recycling output coupler in a waveguided illumination system, a series of reflectors (e.g., beam splitters) is disposed in a waveguide over which a half-wave plate is partially disposed proximate to the first reflector in the series. Illumination light in a first polarization propagating in the waveguide is selectively reflected by the first upstream reflector, which is polarization sensitive, to the half-wave plate. The half-wave plate converts the illumination light to a second orthogonal polarization which is incident on the microdisplay in the correct polarization. Light in the second orthogonal polarization that is transmitted by the upstream reflector is reflected by the second downstream reflector to the microdisplay. Accordingly, illumination light having single correct polarization is incident on the microdisplay.

In a second exemplary embodiment of a polarization-recycling output coupler in a waveguided illumination system, the half-wave plate is embedded in the waveguide between the reflectors. The first upstream reflector is polarization sensitive to selectively reflect and out-couple illumination light in a first polarization that is correct for the microdisplay. The upstream reflector transmits illumination light in the second orthogonal state which is converted by the half-wave plate to the first polarization state. The second downstream reflector reflects the converted illumination light to out-couple it to the microdisplay.

Advantageously, each exemplary component of the present polarization-recycling waveguided illumination system may be utilized individually or in various combinations to implement microdisplay illumination that increases the efficiency of utilization of light energy from the unpolarized source by recycling light into an appropriate state of polarization. In addition, by utilizing a series of reflectors (or a continuous reflective surface in the case of the polarization-recycling waveguide), multiple polarization-sensitive reflectors are implemented that enable fractional conversion of illumination light to the desired polarization state. Such arrangement can increase illumination uniformity for the microdisplay.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 shows a pictorial partially cutaway view of an illustrative HMD device that is configured with the present polarization-recycling waveguided microdisplay illumination system;

FIG. 2 illustratively shows virtual images that are overlayed onto real-world images within a field of view (FOV) of a mixed-reality head-mounted display (HMD) device;

FIG. 3 shows illustrative components of a display device that may be utilized in an HMD device;

FIGS. 4, 5, and 6 show an illustrative waveguided illumination system having a polarization-recycling output coupler;

FIG. 7 shows an illustrative alternative embodiment of a polarization-recycling output coupler in a waveguided illumination system;

FIGS. 8A and 8B show an illustrative polarization-recycling waveguide;

FIG. 9 shows an illustrative polarization-recycling input coupler;

FIG. 10 shows a pictorial front view of an illustrative sealed visor that may be used as a component of an HMD device;

FIG. 11 shows a pictorial rear view of an illustrative sealed visor;

FIG. 12 shows a partially disassembled view of an illustrative sealed visor;

FIG. 13 shows an illustrative arrangement of diffractive optical elements (DOEs) configured for in-coupling, exit pupil expansion in two directions, and out-coupling;

FIG. 14 shows a simplified side view of an illustrative virtual display system that includes a waveguide-based optical combiner that may be used in an HMD device;

FIG. 15 is a pictorial view of an illustrative example of a virtual-reality or mixed-reality HMD device that may use the present polarization-recycling waveguided microdisplay illumination system;

FIG. 16 shows a block diagram of an illustrative example of a virtual-reality or mixed-reality HMD device that may use the present polarization-recycling waveguided microdisplay illumination system; and

FIG. 17 schematically shows an illustrative example of a computing system that may use the present polarization-recycling waveguided microdisplay illumination system.

Like reference numerals indicate like elements in the drawings. Elements are not drawn to scale unless otherwise indicated.

### DETAILED DESCRIPTION

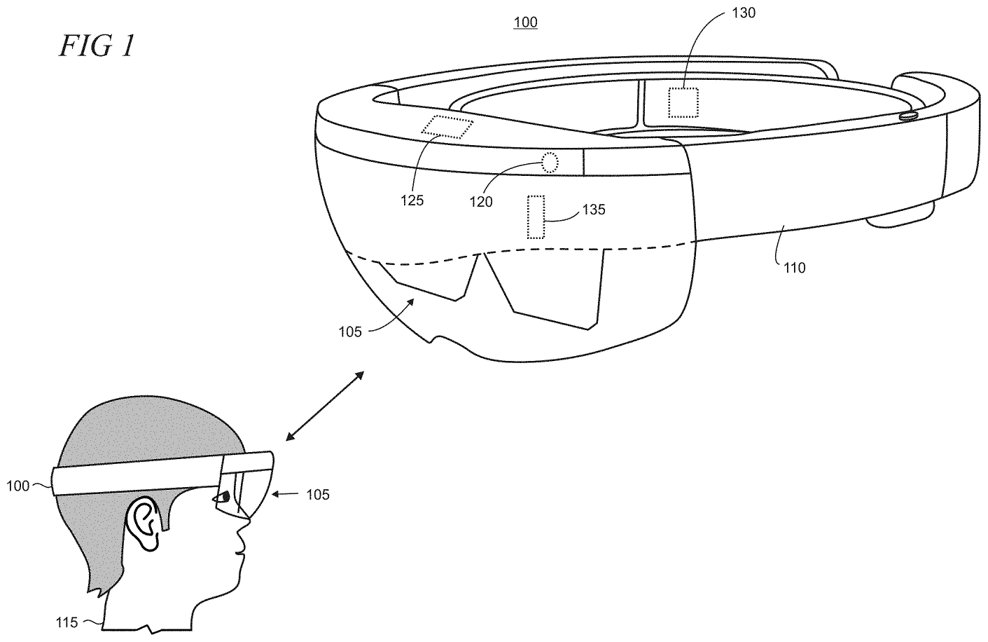

FIG. 1 shows a pictorial partially cutaway view of an illustrative HMD device 100 that is configurable to utilize the present polarization-recycling waveguided microdisplay illumination system. In this example, the HMD device includes a display device 105 and a frame 110 that wraps around the head of a user 115 to position the display device near the user's eyes to provide a virtual-reality or mixed-reality experience to the user.

Any suitable technology and configuration may be used to display images using the display device. For example, for a virtual-reality experience, the display device may be an opaque light-emitting diode (LED) display, a liquid crystal display (LCD), a micro-electromechanical system (MEMS) scanner display system, or any other suitable type of opaque display device. In some implementations, outward facing cameras 120 may be provided that capture images of the surrounding physical environment, and these captured images may be rendered on the display device 105 along with computer-generated virtual images that augment the captured images of the physical environment.

For a mixed-reality experience, the display device 105 may be see-through so that the user of the HMD device 100 can view physical, real-world objects in the physical environment over which pixels for virtual objects are overlayed. For example, the display device may include one or more partially transparent waveguides used in conjunction with a virtual image-producing imager or display engine such as, for example, a microdisplay panel comprising RGB (red, green, blue) LEDs, an organic LED (OLED) array, LCoS device, and/or MEMS device, or any other suitable displays or microdisplays operating in transmission, reflection, or emission. The imager may also include electronics such as processors, optical components such as mirrors and/or lenses, and/or mechanical and other components that enable a virtual display to be composed and provide one or more input optical beams to the display system.

The frame 110 may further support additional components of the HMD device 100, including a processor 125, an inertial measurement unit (IMU) 130, and an eye tracker 135. The processor may include logic and associated computer memory configured to receive sensory signals from the IMU and other sensors, to provide display signals to the display device 105, to derive information from collected data, and to enact various control processes described herein.

The display device 105 may be arranged in some implementations as a near-eye display. In a near-eye display, the imager does not actually shine the images on a surface such as a glass lens to create the display for the user. This is not feasible because the human eye cannot focus on something that is that close. Rather than create a visible image on a surface, the near-eye display uses an optical system to form a pupil and the user's eye acts as the last element in the optical chain and converts the light from the pupil into an image on the eye's retina as a virtual display. It may be appreciated that the exit pupil is a virtual aperture in an optical system. Only rays which pass through this virtual aperture can exit the system. Thus, the exit pupil describes a minimum diameter of the virtual image light after leaving the display system. The exit pupil defines the eyebox which comprises a spatial range of eye positions of the user in which the virtual images projected by the display device are visible.

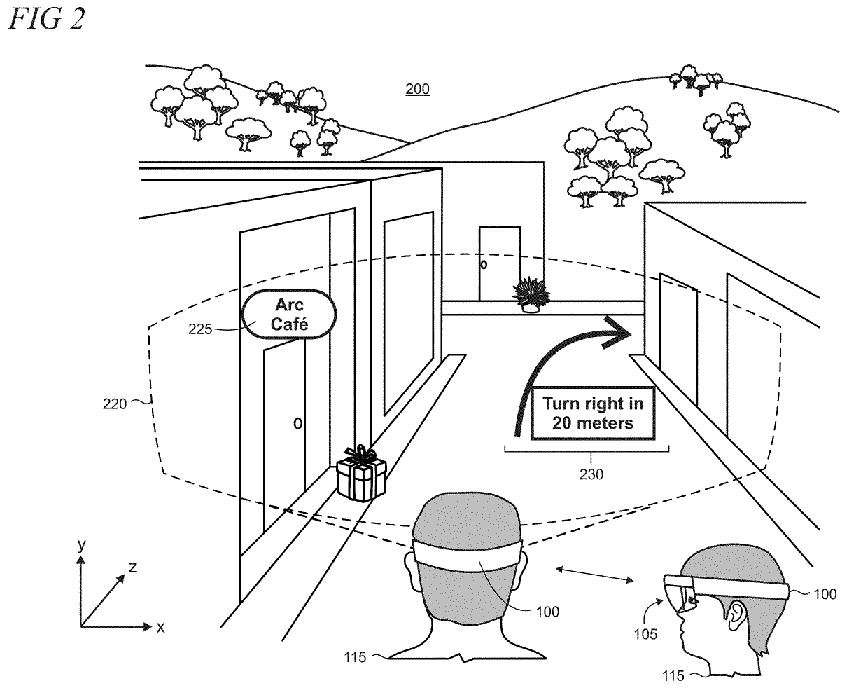

FIG. 2 shows the HMD device 100 worn by a user 115 as configured for mixed-reality experiences in which the display device 105 is implemented as a near-eye display system having at least a partially transparent, see-through waveguide, among various other components. As noted above, a suitable display engine (not shown) generates virtual images that are guided by the waveguide in the display device to the user. Being see-through, the waveguide in the display device enables the user to perceive light from the real world.

The see-through waveguide-based display device 105 can render images of various virtual objects that are superimposed over the real-world images that are collectively viewed using the see-through waveguide display to thereby create a mixed-reality environment 200 within the HMD device's FOV (field of view) 220. It is noted that the FOV of the real world and the FOV of the images in the virtual world are not necessarily identical, as the virtual FOV provided by the display device is typically a subset of the real FOV. FOV is typically described as an angular parameter in horizontal, vertical, or diagonal dimensions.

It is noted that FOV is just one of many parameters that are typically considered and balanced by HMD device designers to meet the requirements of a particular implementation. For example, such parameters may include eyebox size, brightness, transparency and duty time, contrast, resolution, color fidelity, depth perception, size, weight, form-factor, and user comfort (i.e., wearable, visual, and social), among others.

In the illustrative example shown in FIG. 2, the user 115 is physically walking in a real-world urban area that includes city streets with various buildings, stores, etc., with a countryside in the distance. The FOV of the cityscape viewed on HMD device 100 changes as the user moves through the real-world environment and the device can render static and/or dynamic virtual images over the real-world view. In this illustrative example, the virtual images include a tag 225 that identifies a restaurant business and directions 230 to a place of interest in the city. The mixed-reality environment 200 seen visually on the waveguide-based display device may also be supplemented by audio and/or tactile/haptic sensations produced by the HMD device in some implementations.

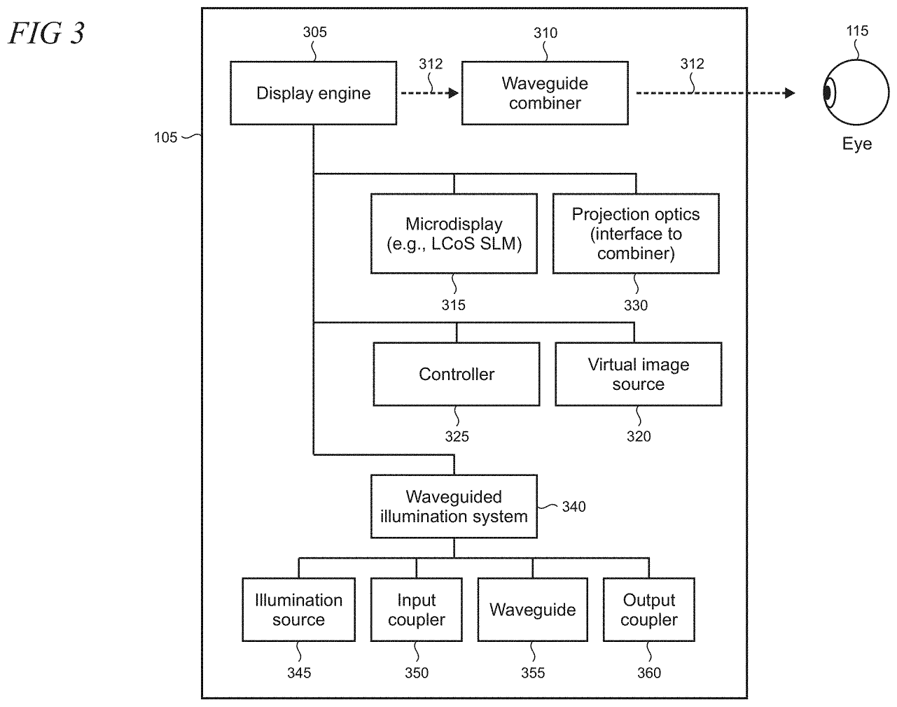

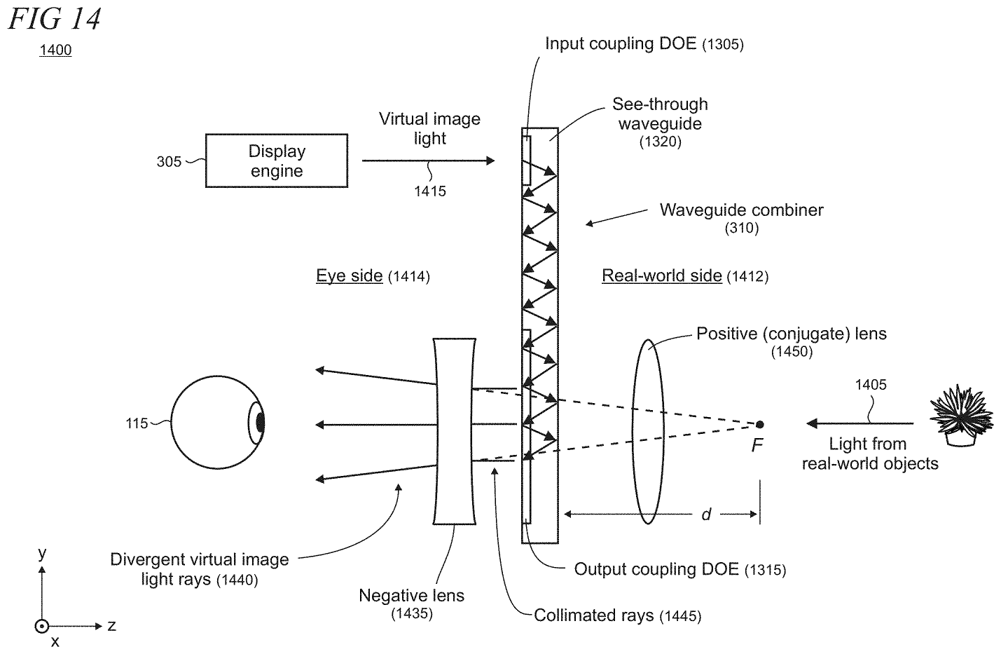

FIG. 3 shows illustrative components of the display device 105 that may be utilized in the HMD device 100 in an illustrative mixed-reality embodiment. The display device includes a display engine 305 and a waveguide combiner 310 to provide virtual and real images to the user 115 over a light path 312. In this illustrative example, the display engine 305 includes a microdisplay 315 such as an LCoS SLM (spatial light modulator) that is arranged to supply virtual images from a source 320 to the waveguide combiner 310 responsively to instructions from a controller 325. An illustrative embodiment of the waveguide combiner is described in more detail below in the text accompanying FIG. 14.

Projection optics 330 may be utilized to manipulate or shape the virtual images, as needed, to support an optical interface between the microdisplay 315 and the waveguide combiner 310. The projection optics may include optical elements such as lenses, mirrors, filters, gratings, and the like, and may further include mechanical elements such as MEMS devices.

The LCoS SLM 315 may be conventionally configured to enable modulation, at any point on its surface, through a local change of the optical path, the intensity, phase, or polarization of an incident light beam from a waveguided illumination system 340. The LCoS SLM is non-emissive and therefore requires a separate illumination source which is modulated by the LCoS SLM. The illumination system is adapted to provide light for illuminating the LCoS SLM. The illumination system includes an illumination source 345, input coupler 350, waveguide 355, and output coupler 360 which are discussed in more detail below.

The LCoS SLM operates in reflection to thereby propagate the illumination light twice through the modulating layer which, in turn, typically increases the dynamic range. LCoS SLMs are microdisplays that comprise a layer of nematic liquid crystals disposed between a transparent electrode and a matrix of CMOS (complementary metal oxide semiconductor) integrated circuitry on a silicon backplane. A reflective treatment may be deposited on the CMOS matrix. Anchoring layers on one side of the electrode and on the reflective layer enable the liquid crystal molecules to be oriented in a direction parallel to the surface. An electric field maintained between the transparent electrode and the semiconductor controls the local average molecular orientation of the liquid crystal and modulates its refractive index.

In an illustrative implementation, a waveguide in the waveguide combiner 310 operates using a principle of total internal reflection (TIR) so that light can be coupled among the various optical elements in the HMD device 100 (FIG. 1). TIR is a phenomenon which occurs when a propagating light wave strikes a medium boundary (e.g., as provided by the optical substrate of a waveguide or prism) at an angle larger than the critical angle with respect to the normal to the surface. In other words, the critical angle (θ_{c}) is the angle of incidence above which TIR occurs, which is given by Snell's Law, as is known in the art. More specifically, Snell's law states that the critical angle (θ_{c}) is specified using the following equation:

θ_{c}=sin⁻¹(n2/n1)

where θ_{c} is the critical angle for two optical mediums (e.g., the waveguide substrate and air or some other medium that is adjacent to the substrate) that meet at a medium boundary, n1 is the index of refraction of the optical medium in which light is traveling towards the medium boundary (e.g., the waveguide substrate, once the light is coupled therein), and n2 is the index of refraction of the optical medium beyond the medium boundary (e.g., air or some other medium adjacent to the waveguide substrate).

In other illustrative implementations, a waveguide in the waveguide combiner 310 may be configured with reflectors and/or mirrored surfaces to control light propagation within a defined spatial region in the waveguide. For example, reflective coatings using one or more dielectric layers and/or other suitable interfaces or structures may be included to guide light within the waveguide. The reflectors and/or reflective surfaces may be polarization sensitive in some embodiments as discussed below.

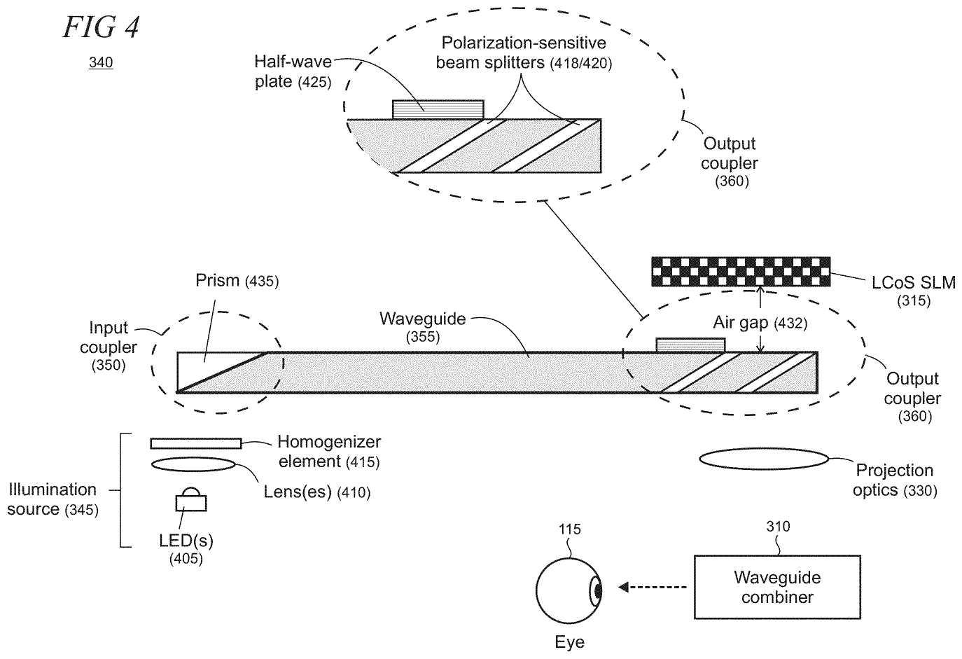

FIG. 4 shows an illustrative waveguided illumination system 340 that is configured to provide illumination light from a source to the LCoS SLM 315 to thereby enable the display to supply virtual images to the waveguide combiner 310 via the projection optics 330 for rendering to the user 115. An air gap 432 between the LCoS SLM and the waveguide may be utilized in some implementations of the present principles, however such air gap may not necessarily be required in all implementations. The illumination source 345 may comprise, for example, one or more light emitting diodes (LEDs) 405 or other suitable sources of illumination light. The illumination source may further include one or more lenses 410 and/or a homogenizer element 415 that may be utilized to shape or distribute the light from the LED prior to being in-coupled by the input coupler 350 to the waveguide 355 in some cases. For example, illumination systems implemented with LEDs may typically experience uneven distribution of light intensity. A lens system and/or homogenizer may be utilized to provide more uniformity of brightness in the display system. The input coupler in this illustrative example is implemented as an in-coupling prism 435 or wedge reflector, however it may be appreciated that various alternative input coupling arrangements may also be utilized.

Each of the input coupler 350, waveguide 355, and output coupler 360 in the illumination system 340 may be adapted to implement polarization recycling in accordance with the present principles. These polarization-recycling components may be used individually or in various combinations to meet the particular requirements of a given illumination application.

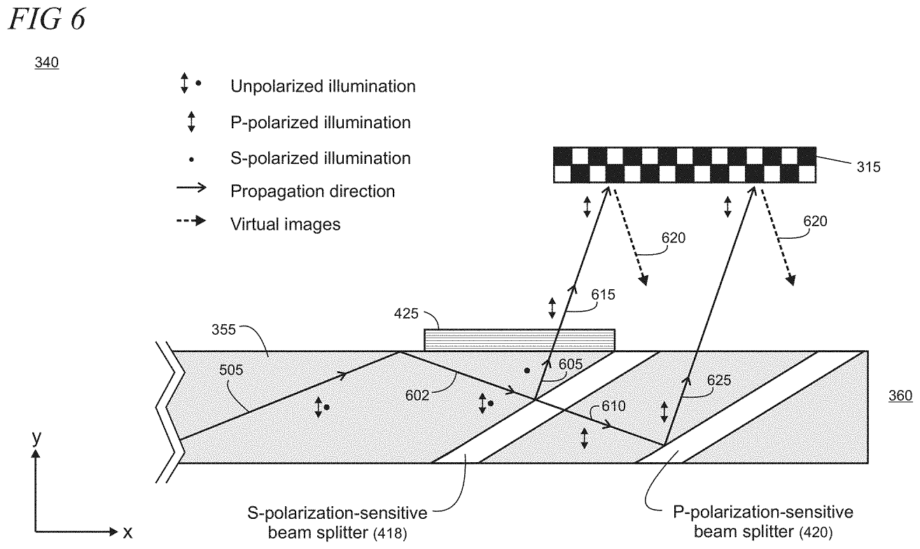

In the illustrative example shown in FIG. 4, the output coupler 360 is arranged to be polarization-recycling and includes polarizing beam splitters 418 and 420 and a transmissive half-wave plate 425. The half-wave plate is a polarization-retarding waveplate that resolves a light wave into two orthogonal linear polarization components and imparts a phase shift between them. Illustrative examples of a polarization-recycling waveguide and input coupler are respectively shown in FIGS. 8A/B and 9 and described in the accompanying text below.

As shown in FIG. 5, light 505 from the illumination source 345 is in-coupled by the input coupler 350 to the waveguide 355. The illumination light is out-coupled from the waveguide by the output coupler 360 to the LCoS SLM microdisplay 315 to enable virtual images 510 to be projected using the projection optics 330 to the waveguide combiner 310. The waveguide combiner renders the virtual images to the user 115 along with light from the real world in mixed-reality scenarios, as discussed above.

FIG. 6 provides an enlarged view of the output coupler 360. As shown, the illumination light 505 from the source propagates in the waveguide 355, for example in TIR, towards the output coupler in a plane of incidence (i.e., the x-y plane). The light from the LED is unpolarized, as the direction of its electric field fluctuates randomly in time. Unpolarized light may be represented by two orthogonal linear polarization states referred to as p-polarization and s-polarization. P-polarized (from the German parallel) light has an electric field polarized parallel to the plane of incidence, while s-polarized (from the German senkrecht) light is perpendicular to the plane of incidence. S-polarized light is indicated by a dot symbol in the drawings while p-polarized light is indicated by a vertical double arrow. Unpolarized light is indicated by both the dot and arrow.

The unpolarized illumination light encounters the first (i.e., upstream) beam splitter 418 which is arranged with sensitivity to s-polarized light. For example, the beam splitters may be implemented using a polarization-sensitive coating or use a wire grid polarizer arrangement. As shown, unpolarized light 602 is incident on the beam splitter 418 which splits the incident light into a reflected s-polarized beam 605 and a transmitted p-polarized beam 610. The reflected s-polarized beam propagates upwards to the half-wave plate 425 which converts the state of the beam 605 from s-polarized to p-polarized (i.e., an orthogonal state), as shown by beam 615. That light continues to the LCoS SLM 315 to provide illumination for virtual images 620.

The transmitted p-polarized beam 610 continues to propagate in the waveguide 355 until it becomes incident on the second (i.e., downstream) beam splitter 420 which is p-polarization-sensitive (i.e., the opposite polarization sensitivity to the upstream beam splitter). The incident beam is reflected upwards towards the LCoS SLM 315 as a p-polarized beam 625 to provide illumination for virtual images 620. As shown, the outbound virtual image light is configured in a non-telecentric path in this particular illustrative embodiment to avoid being blocked by the half-wave plate 425 in which the degree of telecentricity utilized may vary according to a given illumination system geometry. It may be appreciated that the output coupler 360 recycles light that would otherwise be in the incorrect polarization state for the LCoS SLM to thereby effectively double the efficiency of the illumination system.

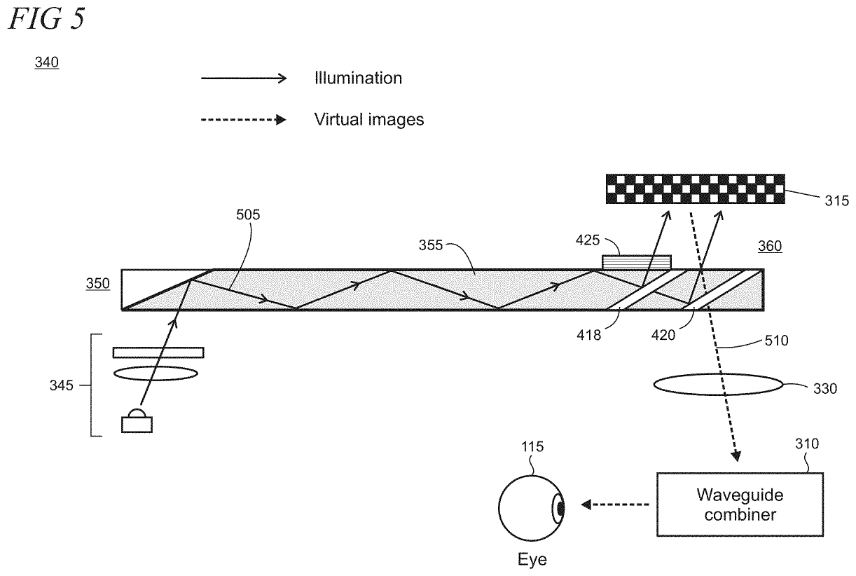

FIG. 7 shows an illustrative alternative embodiment of a polarization-recycling output coupler 700 in a waveguided illumination system 340 (FIG. 3). In this embodiment, a transmissive half-wave plate 705 is embedded in the waveguide 355 and both the upstream and downstream polarizing beam splitters 710 and 715 have the same polarization sensitivity. For example, each may split incident light into reflected p-polarized beams and transmitted s-polarized beams.

An unpolarized illumination beam 702 incident on the first beam splitter 710 is split into a reflected p-polarized beam 720 towards the LCoS SLM 315 to provide illumination for virtual images 740. A transmitted s-polarized beam 725 is converted by the half-wave plate 705 to an orthogonal polarization state, from s-polarized to p-polarized, as shown by beam 730. Light in the converted polarization state continues to propagate in the waveguide 355 to the downstream beam splitter where it is reflected upwards towards the LCoS SLM as a p-polarized beam 735 to provide illumination for virtual images 740.

FIGS. 8A and 8B show an illustrative example of a polarization-recycling waveguide 800 in a waveguided illumination system 340. The waveguide includes an optical substrate 805 that includes polarization-sensitive reflectors 810 and 815 or mirrored surfaces that may be disposed on the top and bottom of the waveguide substrate, for example as dielectric coatings or other suitable structure or treatment that reflect s-polarized light and transmit p-polarized light. The top of the waveguide substrate further supports a quarter-wave plate 820 disposed over the top reflector and a mirror 825 disposed over the plate.

As shown in the exploded view in FIG. 8B, unpolarized illumination light 830 from the source (not shown) includes a p-polarized beam 835 that is transmitted by the top reflector 810 to escape the waveguide substrate 805. The reflected component, an s-polarized beam 840 continues to propagate in the waveguide.

The linearly p-polarized beam 835 is converted by the quarter-wave plate 820 to circularly-polarized light (which is arbitrarily designated as right-hand circularly-polarized light 845). When the circularly-polarized light 845 reflects from the mirror 825, it changes its handedness, in this example, from right-hand circularly-polarized to left-hand circularly-polarized light 850. That light then passes through the quarter-wave plate which changes the polarization state from circular to linear such that the emerging beam 855 is s-polarized.

As the linearly p-polarized illumination light 835 escaping the waveguide substrate makes two passes through the quarter-wave plate, it reenters the waveguide in an orthogonal linear polarization state as an s-polarized beam 855. It may thus be appreciated that light propagating through the illumination system at various angles and spatial locations will be converted to the desired linear polarization state for the LCoS SLM with each bounce along the polarization-recycling waveguide 800.

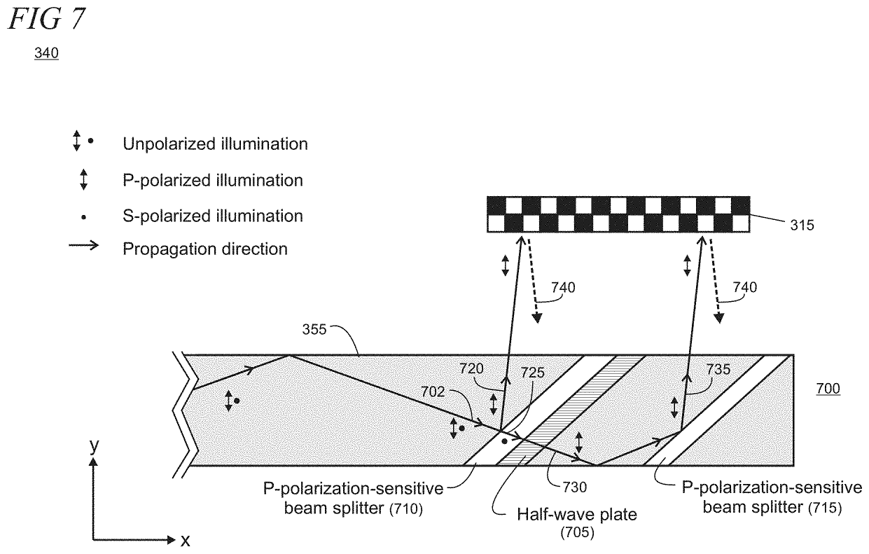

FIG. 9 shows an illustrative example of a polarization-recycling input coupler 900 in a waveguided illumination system 340 in which a polarization-sensitive reflector 905 and half-wave plate 910 are disposed upstream in an input light path between an in-coupling reflector 915 or prism and the illumination source 345 which provides unpolarized beams 920 and 925. In this illustrative example, the polarization-sensitive reflector is arranged to reflect s-polarized illumination light into the waveguide 355, as shown by beam 930, and transmit p-polarized illumination light, as shown by beam 935. The reflected s-polarized beam 930 propagates along the waveguide, as shown.

The p-polarized beam 935 is converted by the half-wave plate 910 to an orthogonal polarization state, from p-polarized to s-polarized, as shown by beam 940. The converted beam 940 is reflected by the downstream in-coupling reflector 915 into, and propagates along, the waveguide 355, as shown. It may be appreciated that the input coupler 900 recycles light that would otherwise be in the incorrect polarization state for the LCoS SLM to thereby effectively double the efficiency of the illumination system.

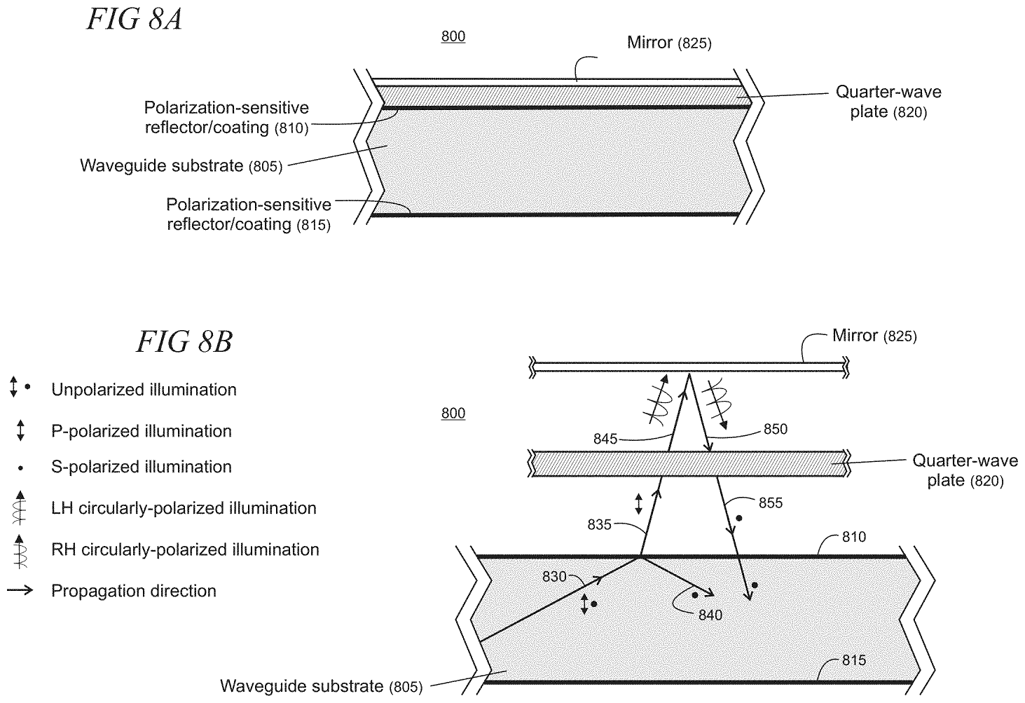

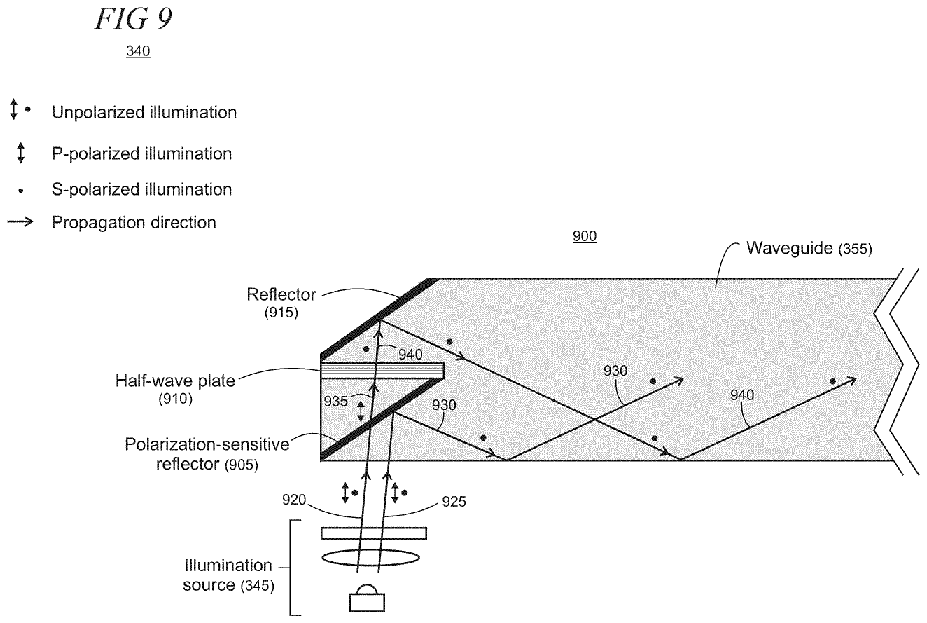

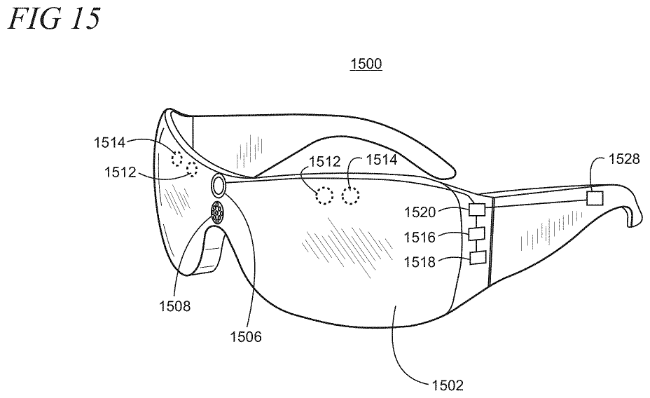

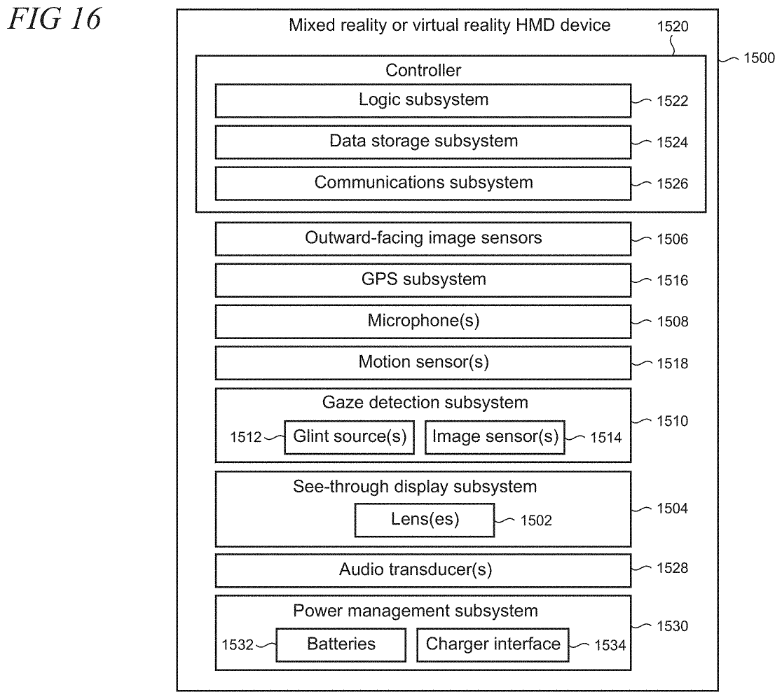

FIGS. 10 and 11 show respective front and rear views of an illustrative example of a visor 1000 that incorporates an internal near-eye display device 105 (FIGS. 1 and 2) that is used in the HMD device 100 as worn by a user 115. The visor, in some implementations, may be sealed to protect the internal display device. The visor typically interfaces with other components of the HMD device such as head-mounting/retention systems and other subsystems including sensors, power management, controllers, etc., as illustratively described in conjunction with FIGS. 15 and 16. Suitable interface elements (not shown) including snaps, bosses, screws, and other fasteners, etc. may also be incorporated into the visor.

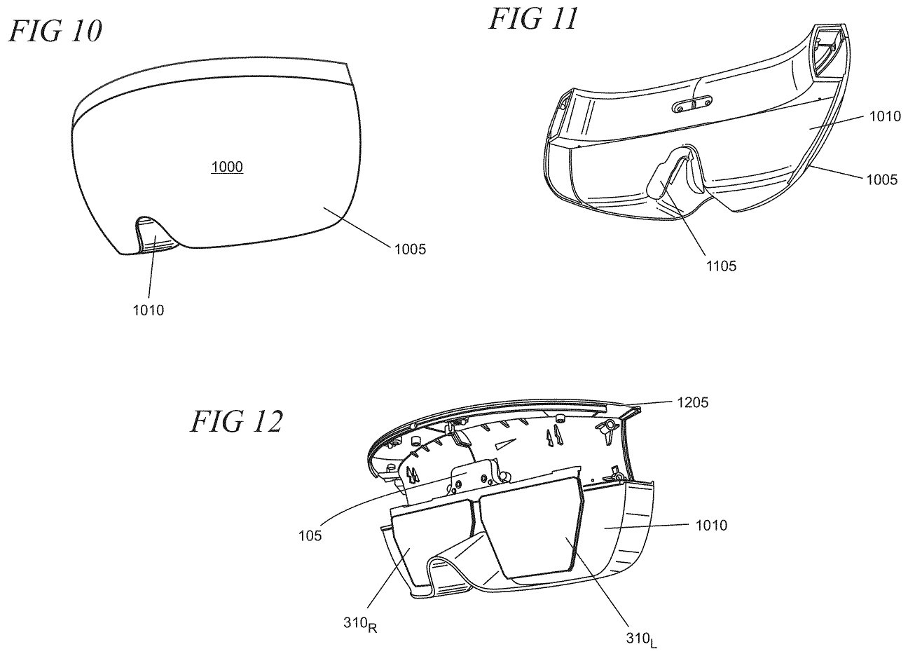

The visor 1000 may include see-through front and rear shields, 1005 and 1010 respectively, that can be molded using transparent or partially transparent materials to facilitate unobstructed vision to the display device and the surrounding real-world environment. Treatments may be applied to the front and rear shields such as tinting, mirroring, anti-reflective, anti-fog, and other coatings, and various colors and finishes may also be utilized. The front and rear shields are affixed to a chassis 1205 shown in the disassembled view in FIG. 12.

The sealed visor 1000 can physically protect sensitive internal components, including the display device 105, when the HMD device is operated and during normal handling for cleaning and the like. The display device in this illustrative example includes left and right waveguide combiners 310L and 310R that respectively provide virtual images to the user's left and right eyes for mixed- and/or virtual-reality applications. The visor can also protect the display device from environmental elements and damage should the HMD device be dropped or bumped, impacted, etc.

As shown in FIG. 11, the rear shield 1010 is configured in an ergonomically suitable form 1105 to interface with the user's nose, and nose pads and/or other comfort features can be included (e.g., molded-in and/or added-on as discrete components). In some applications, the sealed visor 1010 can also incorporate some level of optical diopter curvature (i.e., eye prescription) within the molded shields in some cases. The sealed visor 1000 can also be configured to incorporate a conjugate lens pair as shown in FIG. 14 and described in the accompanying text.

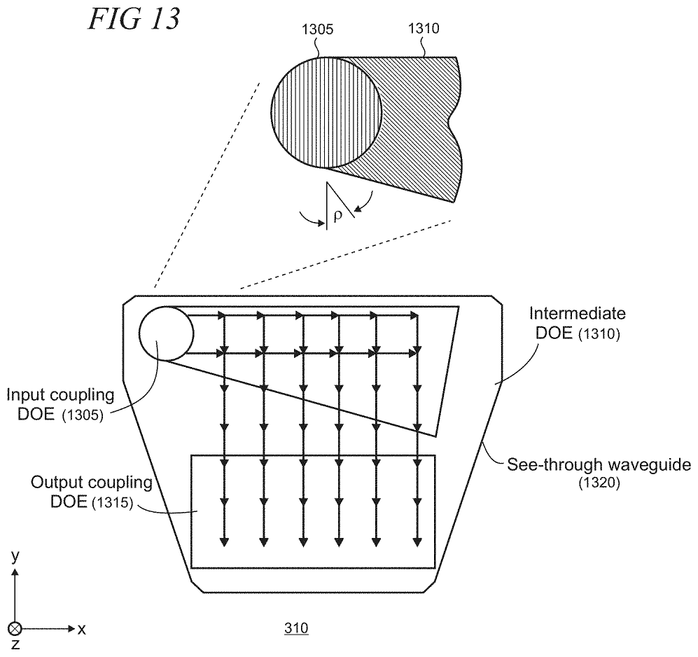

FIG. 13 shows an illustrative waveguide combiner 310 having multiple diffractive optical elements (DOEs) that may be used in an embodiment of the display device 105 (FIG. 1) to provide input coupling, expansion of the exit pupil in two directions, and output coupling of virtual images from the display engine 305 (FIG. 3) to the user's eye. Each DOE is an optical element comprising a periodic structure that can modulate various properties of light in a periodic pattern such as the direction of optical axis, optical path length, and the like. The structure can be periodic in one dimension such as one-dimensional (1D) grating and/or be periodic in two dimensions such as two-dimensional (2D) grating. DOEs may comprise, for example, surface relief grating (SRG) structures and volumetric holographic (VHG) structures.

The waveguide combiner 310 includes input and output couplers, which may comprise an input coupling DOE 1305, and an output coupling DOE 1315. An intermediate DOE 1310 may be provided that couples light between the input coupling and output coupling DOEs. The input coupling DOE is configured to couple image light comprising one or more imaging beams from the display engine into the waveguide 1320. The intermediate DOE expands the exit pupil in a first direction along a first coordinate axis (e.g., horizontal), and the output coupling DOE expands the exit pupil in a second direction along a second coordinate axis (e.g., vertical) and couples light out of the waveguide to the user's eye (i.e., outwards from the plane of the drawing page). The angle ρ is a rotation angle between the periodic lines of the input coupling DOE and the intermediate DOE as shown. As the light propagates in the intermediate DOE (horizontally from left to right in the drawing), it is also diffracted (in the downward direction) to the output coupling DOE 1315.

While DOEs are shown in this illustrative example using a single input coupling DOE 1305 disposed to the left of the intermediate DOE 1310, which is located above the output coupling DOE, in some implementations, the input coupling DOE may be centrally positioned within the waveguide and one or more intermediate DOEs can be disposed laterally from the input coupling DOE to enable light to propagate to the left and right while providing for exit pupil expansion along the first direction. It may be appreciated that other numbers and arrangements of DOEs may be utilized to meet the needs of a particular implementation. In other implementations of the present polarization-recycling waveguided microdisplay illumination system, optical components operating in reflection may be utilized for one or more of input coupler, intermediate coupler, or output coupler.

FIG. 14 shows a simplified side view of an illustrative virtual display system 1400 that is incorporated into the display device 105 (FIG. 1) and which may be used in the HMD device 100 to render virtual images. The virtual display system may function as an optical combiner by superimposing the rendered virtual images over the user's view of light from real-world objects 1405 to thus form the mixed-reality display.

The display system includes at least one partially transparent (i.e., see-through) waveguide 1320 that is configured to propagate visible light. While a single waveguide is shown in FIG. 14 for sake of clarity in exposition of the present principles, it will be appreciated that a plurality of waveguides may be utilized in some applications. For example, three waveguides may be utilized in which a single waveguide supports each color component in an RGB (red, green, blue) color space.

The waveguide 1320 facilitates light transmission between the virtual image source and the eye. One or more waveguides can be utilized in the near-eye display system because they are transparent and because they are generally small and lightweight. This is desirable in applications such as HMD devices where size and weight are generally sought to be minimized for reasons of performance and user comfort. Use of the waveguide 1320 can enable the virtual image source to be located out of the way, for example, on the side of the user's head or near the forehead, leaving only a relatively small, light, and transparent waveguide optical element in front of the eyes.

The user 115 can look through the waveguide 1320 to see real-world objects on the real-world side of the display device 105 (the real-world side is indicated by reference numeral 1412 in FIG. 14). For the virtual part of the FOV of the display system, virtual image light 1415 is provided by the display engine 305. The virtual image light is in-coupled to the waveguide by an input coupling DOE 1305 and propagated through the waveguide in total internal reflection. The image light is out-coupled from the waveguide by an output coupling DOE 1315. The combination of see-through waveguide and coupling elements may be referred to as a mixed-reality optical combiner because it functions to combine real-world and virtual-world images into a single display.

Typically, in such waveguide-based optical combiners, the input pupil needs to be formed over a collimated field, otherwise each waveguide exit pupil will produce an image at a slightly different distance. This results in a mixed visual experience in which images are overlapping with different focal depths in an optical phenomenon known as focus spread. The collimated inputs and outputs in conventional waveguide-based display systems provide virtual images displayed by the display device that are focused at infinity.

In alternative embodiments, the optical combiner functionality provided by the waveguide and DOEs may be implemented using a reflective waveguide combiner. For example, partially reflective surfaces may be embedded in a waveguide and/or stacked in a geometric array to implement an optical combiner that uses partial field propagation. The reflectors can be half-tone, dielectric, holographic, polarized thin layer, or be fractured into a Fresnel element.

In other embodiments, the principles of the present polarization-recycling waveguided microdisplay illumination system may be implemented using a reflective waveguide combiner having wavelength-sensitive reflective coatings with any suitable in-coupling and/or out-coupling methods. A reflective waveguide combiner may utilize a single waveguide in some implementations for all colors in the virtual images which may be desirable in some applications. By comparison, diffractive combiners typically require multiple waveguides to meet a target FOV in polychromatic applications due to limitations on angular range that are dictated by the waveguide TIR condition.

The present polarization-recycling waveguided microdisplay illumination system may also be utilized with various other waveguide/coupling configurations beyond reflective and diffractive. For example, it may be appreciated that the principles of the present invention may be alternatively applied to waveguides that are refractive, polarized, hybrid diffractive/refractive, phase multiplexed holographic, and/or achromatic metasurfaces.

A negative lens 1435 is located on the eye side of the waveguide 1320 (the eye side is indicated by reference numeral 1414 in FIG. 14). The negative lens acts over the entire extent of the eyebox associated with the user's eye to thereby create the diverging rays 1440 from the collimated rays 1445 that exit the output coupling DOE 1315. When the display engine 305 is operated to project virtual images that are in-coupled into the waveguide 1320, the output diverging rays present the virtual images at a predetermined focal depth, d, from the display system at an apparent or virtual point of focus, F. For example, if the negative lens is configured with −0.5 diopters of optical power, then d is equal to 2 m.

To ensure that the user's view of the real world remains unperturbed by the negative lens, a conjugate positive (i.e., convex) lens 1450 is located on the real-world side of the waveguide 1320 to compensate for the impact of the negative lens on the eye side. The conjugate pair of positive and negative lenses may be referred to as a push-pull lens pair in some contexts. In some applications, the functionality of the negative lens may be provided by a discrete standalone optical element. In other applications, one or more of the elements in the display device may be configured to incorporate the negative lens as an additional functionality. For example, the negative lens functionality can be integrated into the output coupling DOE and/or waveguide in the display device using any suitable technique.

Different amounts of optical power may be utilized to provide for focal planes that are located at other distances to suit requirements of a particular application. The power of the negative lens 1435 does not affect the zeroth diffraction order that travels in TIR down the waveguide 1320 (i.e., from top to bottom in the drawings), but instead only the diffracted out-coupled field. In addition, the see-through field is not affected by the negative lens because whatever portion of the see-through field that is diffracted by the output coupling DOE 1315 is trapped by TIR in the waveguide and is therefore not transmitted to the user's eye.

As noted above, the present polarization-recycling waveguided microdisplay illumination system may be utilized in mixed- or virtual-reality applications. FIG. 15 shows one particular illustrative example of a mixed-reality HMD device 1500, and FIG. 16 shows a functional block diagram of the device 1500. The HMD device 1500 provides an alternative form factor to the HMD device 100 shown in FIGS. 1, 2, and 10-12. HMD device 1500 comprises one or more lenses 1502 that form a part of a see-through display subsystem 1504, so that images may be displayed using lenses 1502 (e.g., using projection onto lenses 1502, one or more waveguide systems, such as a near-eye display system, incorporated into the lenses 1502, and/or in any other suitable manner).

HMD device 1500 further comprises one or more outward-facing image sensors 1506 configured to acquire images of a background scene and/or physical environment being viewed by a user and may include one or more microphones 1508 configured to detect sounds, such as voice commands from a user. Outward-facing image sensors 1506 may include one or more depth sensors and/or one or more two-dimensional image sensors. In alternative arrangements, as noted above, a mixed-reality or virtual-reality display system, instead of incorporating a see-through display subsystem, may display mixed-reality or virtual-reality images through a viewfinder mode for an outward-facing image sensor.

The HMD device 1500 may further include a gaze detection subsystem 1510 configured for detecting a direction of gaze of each eye of a user or a direction or location of focus, as described above. Gaze detection subsystem 1510 may be configured to determine gaze directions of each of a user's eyes in any suitable manner. For example, in the illustrative example shown, a gaze detection subsystem 1510 includes one or more glint sources 1512, such as infrared (IR) light or visible sources, that are configured to cause a glint of light to reflect from each eyeball of a user, and one or more image sensors 1514, such as inward-facing sensors, that are configured to capture an image of each eyeball of the user. Changes in the glints from the user's eyeballs and/or a location of a user's pupil, as determined from image data gathered using the image sensor(s) 1514, may be used to determine a direction of gaze.

In addition, a location at which gaze lines projected from the user's eyes intersect the external display may be used to determine an object at which the user is gazing (e.g., a displayed virtual object and/or real background object). Gaze detection subsystem 1510 may have any suitable number and arrangement of light sources and image sensors. In some implementations, the gaze detection subsystem 1510 may be omitted.

The HMD device 1500 may also include additional sensors. For example, HMD device 1500 may comprise a global positioning system (GPS) subsystem 1516 to allow a location of the HMD device 1500 to be determined. This may help to identify real-world objects, such as buildings, etc., that may be located in the user's adjoining physical environment.

The HMD device 1500 may further include one or more motion sensors 1518 (e.g., inertial, multi-axis gyroscopic, or acceleration sensors) to detect movement and position/orientation/pose of a user's head when the user is wearing the system as part of a mixed-reality or virtual-reality HMD device. Motion data may be used, potentially along with eye-tracking glint data and outward-facing image data, for gaze detection, as well as for image stabilization to help correct for blur in images from the outward-facing image sensor(s) 1506. The use of motion data may allow changes in gaze direction to be tracked even if image data from outward-facing image sensor(s) 1506 cannot be resolved.

In addition, motion sensors 1518, as well as microphone(s) 1508 and gaze detection subsystem 1510, also may be employed as user input devices, such that a user may interact with the HMD device 1500 via gestures of the eye, neck and/or head, as well as via verbal commands in some cases. It may be understood that sensors illustrated in FIGS. 15 and 16 and described in the accompanying text are included for the purpose of example and are not intended to be limiting in any manner, as any other suitable sensors and/or combination of sensors may be utilized to meet the needs of a particular implementation. For example, biometric sensors (e.g., for detecting heart and respiration rates, blood pressure, brain activity, body temperature, etc.) or environmental sensors (e.g., for detecting temperature, humidity, elevation, UV (ultraviolet) light levels, etc.) may be utilized in some implementations.

The HMD device 1500 can further include a controller 1520 such as one or more processors having a logic subsystem 1522 and a data storage subsystem 1524 in communication with the sensors, gaze detection subsystem 1510, display subsystem 1504, and/or other components through a communications subsystem 1526. The communications subsystem 1526 can also facilitate the display system being operated in conjunction with remotely located resources, such as processing, storage, power, data, and services. That is, in some implementations, an HMD device can be operated as part of a system that can distribute resources and capabilities among different components and subsystems.

The storage subsystem 1524 may include instructions stored thereon that are executable by logic subsystem 1522, for example, to receive and interpret inputs from the sensors, to identify location and movements of a user, to identify real objects using surface reconstruction and other techniques, and dim/fade the display based on distance to objects so as to enable the objects to be seen by the user, among other tasks.

The HMD device 1500 is configured with one or more audio transducers 1528 (e.g., speakers, earphones, etc.) so that audio can be utilized as part of a mixed-reality or virtual-reality experience. A power management subsystem 1530 may include one or more batteries 1532 and/or protection circuit modules (PCMs) and an associated charger interface 1534 and/or remote power interface for supplying power to components in the HMD device 1500.

It may be appreciated that the HMD device 1500 is described for the purpose of example, and thus is not meant to be limiting. It may be further understood that the display device may include additional and/or alternative sensors, cameras, microphones, input devices, output devices, etc. than those shown without departing from the scope of the present arrangement. Additionally, the physical configuration of an HMD device and its various sensors and subcomponents may take a variety of different forms without departing from the scope of the present arrangement.

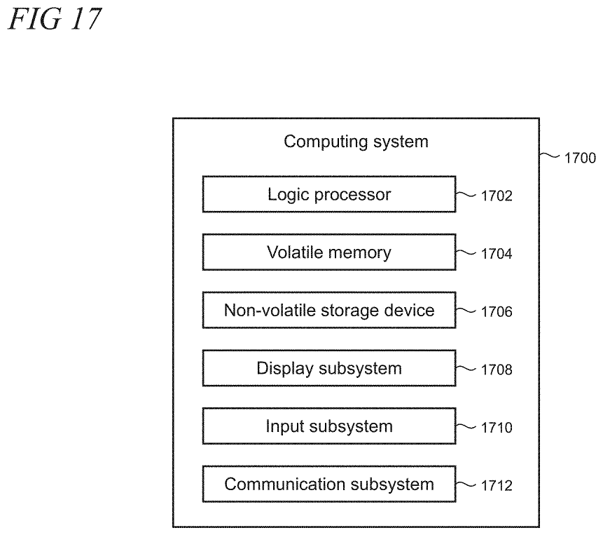

FIG. 17 schematically shows an illustrative example of a computing system 1700 that can enact one or more of the methods and processes described above for the present polarization-recycling waveguided microdisplay illumination system. Computing system 1700 is shown in simplified form. Computing system 1700 may take the form of one or more personal computers, server computers, tablet computers, home-entertainment computers, network computing devices, gaming devices, mobile computing devices, mobile communication devices (e.g., smartphone), wearable computers, and/or other computing devices.

Computing system 1700 includes a logic processor 1702, volatile memory 1704, and a non-volatile storage device 1706. Computing system 1700 may optionally include a display subsystem 1708, input subsystem 1710, communication subsystem 1712, and/or other components not shown in FIG. 17.

Logic processor 1702 includes one or more physical devices configured to execute instructions. For example, the logic processor may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more processors configured to execute software instructions. In addition, or alternatively, the logic processor may include one or more hardware or firmware logic processors configured to execute hardware or firmware instructions. Processors of the logic processor may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects may be run on different physical logic processors of various different machines.

Non-volatile storage device 1706 includes one or more physical devices configured to hold instructions executable by the logic processors to implement the methods and processes described herein. When such methods and processes are implemented, the state of non-volatile storage device 1706 may be transformed—e.g., to hold different data.

Non-volatile storage device 1706 may include physical devices that are removable and/or built-in. Non-volatile storage device 1706 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1706 may include nonvolatile, dynamic, static, read/write, read-only, sequential-access, location-addressable, file-addressable, and/or content-addressable devices. It will be appreciated that non-volatile storage device 1706 is configured to hold instructions even when power is cut to the non-volatile storage device 1706.

Volatile memory 1704 may include physical devices that include random access memory. Volatile memory 1704 is typically utilized by logic processor 1702 to temporarily store information during processing of software instructions. It will be appreciated that volatile memory 1704 typically does not continue to store instructions when power is cut to the volatile memory 1704.

Aspects of logic processor 1702, volatile memory 1704, and non-volatile storage device 1706 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The term “program” may be used to describe an aspect of computing system 1700 typically implemented in software by a processor to perform a particular function using portions of volatile memory, which function involves transformative processing that specially configures the processor to perform the function. Thus, a program may be instantiated via logic processor 1702 executing instructions held by non-volatile storage device 1706, using portions of volatile memory 1704. It will be understood that different programs may be instantiated from the same application, service, code block, object, library, routine, API (application programming interface), function, etc. Likewise, the same program may be instantiated by different applications, services, code blocks, objects, routines, APIs, functions, etc. The term “program” may encompass individual or groups of executable files, data files, libraries, drivers, scripts, database records, etc.

When included, display subsystem 1708 may be used to present a visual representation of data held by non-volatile storage device 1706. This visual representation may take the form of a graphical user interface (GUI). As the herein described methods and processes change the data held by the non-volatile storage device, and thus transform the state of the non-volatile storage device, the state of display subsystem 1708 may likewise be transformed to visually represent changes in the underlying data. Display subsystem 1708 may include one or more display devices utilizing virtually any type of technology; however, one utilizing a MEMS projector to direct laser light may be compatible with the eye-tracking system in a compact manner. Such display devices may be combined with logic processor 1702, volatile memory 1704, and/or non-volatile storage device 1706 in a shared enclosure, or such display devices may be peripheral display devices.

When included, input subsystem 1710 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1712 may be configured to communicatively couple various computing devices described herein with each other, and with other devices. Communication subsystem 1712 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1700 to send and/or receive messages to and/or from other devices via a network such as the Internet.

Various exemplary embodiments of the present polarization-recycling waveguided illumination system for microdisplay are now presented by way of illustration and not as an exhaustive list of all embodiments. An example includes a waveguided polarization-recycling illumination system for use with a non-emissive microdisplay having polarization sensitivity to illumination light, comprising: a waveguide configured to guide illumination light to the non-emissive microdisplay; a series of reflectors disposed in the waveguide along a light path, an upstream reflector on the light path configured to reflect illumination light from an unpolarized illumination source in a first state of linear polarization and transmit illumination light in a second state of linear polarization that is orthogonal to the first state, a downstream reflector on the light path configured to reflect the transmitted illumination light; and a half-wave plate configured to receive illumination light and convert a polarization state of the received illumination light to an orthogonal state to match the polarization sensitivity of the microdisplay.

In another example, the upstream reflector is a polarization-sensitive reflector comprising one of beam splitter, wire grid polarizer, or dielectric coating having one or more layers. In another example, the series of reflectors is disposed in an in-coupler configured to in-couple illumination light from the unpolarized illumination source into the waveguide. In another example, the half-wave plate is disposed in the waveguide between the upstream and downstream reflectors. In another example, the series of reflectors is disposed in an out-coupler configured to out-couple illumination light to the non-emissive microdisplay. In another example, the half-wave plate is disposed in the waveguide between the upstream and downstream reflectors and wherein the half-wave plate receives illumination light transmitted by the upstream reflector and wherein the illumination light in the first state of linear polarization reflected by the upstream reflector matches the polarization sensitivity of the non-emissive microdisplay. In another example, the half-wave plate is disposed on the waveguide on a light path between the upstream reflector and the non-emissive microdisplay and wherein the half-wave plate receives illumination light reflected from the upstream reflector and wherein the illumination light in the first state of linear polarization reflected by the upstream reflector does not match the polarization sensitivity of the non-emissive microdisplay. In another example, the waveguided polarization-recycling illumination system further comprises projection optics configured to project images from the non-emissive microdisplay. In another example, the projection optics are non-telecentric with the non-emissive microdisplay. In another example, the non-emissive microdisplay comprises an LCoS (liquid crystal on silicon) panel.

A further example includes a waveguided polarization-recycling illumination system for use with a non-emissive microdisplay having polarization sensitivity to illumination light, comprising: a waveguide having parallel planar surfaces that is configured to receive illumination light from an unpolarized illumination source; a reflector externally disposed on at least one of the planar surfaces of the waveguide sensitive to a first state of linear polarization of the illumination light; a quarter-wave plate disposed over the reflector; and a mirror disposed over the quarter-wave plate, wherein illumination light in the first state of linear polarization is reflected by the reflector to propagate along the waveguide, and wherein illumination light in a second state of linear polarization orthogonal to the first state is transmitted by the reflector, makes a first pass through the quarter-wave plate, reflects from the mirror, and makes a second pass through the quarter-wave plate to thereby be converted to the first state.

In another example, the first state of polarization matches the polarization sensitivity of the non-emissive microdisplay. In another example, the waveguided polarization-recycling illumination system further comprises an input coupler configured to in-couple the illumination light from the unpolarized illumination source to the waveguide and an output coupler configured to out-couple the illumination light from the waveguide to the non-emissive microdisplay. In another example, the unpolarized illumination source comprises one or more light emitting diodes (LEDs). In another example, the waveguided polarization-recycling illumination system further comprises one or more of a lens or a homogenizer element configured to provide illumination uniformity to the unpolarized illumination source.

A further example includes a head-mounted display (HMD) device, comprising: a non-emissive microdisplay having polarization sensitivity to illumination light; a waveguide-based optical combiner configured to display virtual images from the non-emissive microdisplay to a user of the HMD device that are combined with real-world images; and a waveguided polarization-recycling illumination system comprising an input coupler, a waveguide, and an output coupler that are respectively configured to in-couple illumination light from an unpolarized illumination source, guide the illumination light, and out-couple the illumination light to the non-emissive microdisplay, wherein the waveguided polarization-recycling illumination system further includes at least one polarization-sensitive reflector and a polarization-retarding waveplate that are adapted to recycle illumination from the unpolarized illumination source based on a polarization state of the illumination light by respectively selectively reflecting illumination light and selectively converting polarization of the illumination light to match the polarization sensitivity of the non-emissive microdisplay.

In another example, the input coupler is configured with the at least one polarization-sensitive reflector and the polarization-retarding waveplate comprises a half-wave plate. In another example, the waveguide is configured with the at least one polarization-sensitive reflector and wherein the polarization-retarding waveplate comprises a quarter-wave plate. In another example, the output coupler is configured with the at least one polarization-sensitive reflector and wherein the polarization-retarding waveplate comprises a half-wave plate.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A waveguided polarization-recycling illumination system for use with a non-emissive microdisplay having polarization sensitivity to illumination light, comprising:
a waveguide configured to guide illumination light to the non-emissive microdisplay;
a series of reflectors disposed in the waveguide along a light path, an upstream reflector on the light path configured to reflect illumination light from an unpolarized illumination source in a first state of linear polarization and transmit illumination light in a second state of linear polarization that is orthogonal to the first state, a downstream reflector on the light path configured to reflect the transmitted illumination light; and
a half-wave plate configured to receive illumination light and convert a polarization state of the received illumination light to an orthogonal state to match the polarization sensitivity of the microdisplay.

2. The waveguided polarization-recycling illumination system of claim 1 wherein the upstream reflector is a polarization-sensitive reflector comprising one of beam splitter, wire grid polarizer, or dielectric coating having one or more layers.

3. The waveguided polarization-recycling illumination system of claim 1 wherein the series of reflectors is disposed in an in-coupler configured to in-couple illumination light from the unpolarized illumination source into the waveguide.

4. The waveguided polarization-recycling illumination system of claim 3 wherein the half-wave plate is disposed in the waveguide between the upstream and downstream reflectors.

5. The waveguided polarization-recycling illumination system of claim 3 wherein the downstream reflector comprises a prism.

6. The waveguided polarization-recycling illumination system of claim 1 wherein the series of reflectors is disposed in an out-coupler configured to out-couple illumination light to the non-emissive microdisplay.

7. The waveguided polarization-recycling illumination system of claim 6 wherein the half-wave plate is disposed in the waveguide between the upstream and downstream reflectors and wherein the half-wave plate receives illumination light transmitted by the upstream reflector and wherein the illumination light in the first state of linear polarization reflected by the upstream reflector matches the polarization sensitivity of the non-emissive microdisplay.

8. The waveguided polarization-recycling illumination system of claim 6 wherein the half-wave plate is disposed on the waveguide on a light path between the upstream reflector and the non-emissive microdisplay and wherein the half-wave plate receives illumination light reflected from the upstream reflector and wherein the illumination light in the first state of linear polarization reflected by the upstream reflector does not match the polarization sensitivity of the non-emissive microdisplay.

9. The waveguided polarization-recycling illumination system of claim 6 further comprising projection optics configured to project images from the non-emissive microdisplay.

10. The waveguided polarization-recycling illumination system of claim 9 wherein the projection optics are non-telecentric with the non-emissive microdisplay.

11. The waveguided polarization-recycling illumination system of claim 1 in which the non-emissive microdisplay comprises an LCoS (liquid crystal on silicon) panel.

12. A waveguided polarization-recycling illumination system for use with a non-emissive microdisplay having polarization sensitivity to illumination light, comprising:
a waveguide having parallel planar surfaces that is configured to receive illumination light from an unpolarized illumination source;
a reflector externally disposed on at least one of the planar surfaces of the waveguide sensitive to a first state of linear polarization of the illumination light;
a quarter-wave plate disposed over the reflector; and
a mirror disposed over the quarter-wave plate,
wherein illumination light in the first state of linear polarization is reflected by the reflector to propagate along the waveguide, and wherein illumination light in a second state of linear polarization orthogonal to the first state is transmitted by the reflector, makes a first pass through the quarter-wave plate, reflects from the mirror, and makes a second pass through the quarter-wave plate to thereby be converted to the first state.

13. The waveguided polarization-recycling illumination system of claim 12 wherein the first state of polarization matches the polarization sensitivity of the non-emissive microdisplay.

14. The waveguided polarization-recycling illumination system of claim 13 further comprising an input coupler configured to in-couple the illumination light from the unpolarized illumination source to the waveguide and an output coupler configured to out-couple the illumination light from the waveguide to the non-emissive microdisplay.

15. The waveguided polarization-recycling illumination system of claim 12 in which the unpolarized illumination source comprises one or more light emitting diodes (LEDs).

16. The waveguided polarization-recycling illumination system of claim 15 further comprising one or more of a lens or a homogenizer element configured to provide illumination uniformity to the unpolarized illumination source.

17. A head-mounted display (HMD) device, comprising:
a non-emissive microdisplay having polarization sensitivity to illumination light;
a waveguide-based optical combiner configured to display virtual images from the non-emissive microdisplay to a user of the HMD device that are combined with real-world images; and
a waveguided polarization-recycling illumination system comprising an input coupler, a waveguide, and an output coupler that are respectively configured to in-couple illumination light from an unpolarized illumination source, guide the illumination light, and out-couple the illumination light to the non-emissive microdisplay,
wherein the waveguided polarization-recycling illumination system further includes at least one polarization-sensitive reflector and a polarization-retarding waveplate that are adapted to recycle illumination from the unpolarized illumination source based on a polarization state of the illumination light by respectively selectively reflecting illumination light and selectively converting polarization of the illumination light to match the polarization sensitivity of the non-emissive microdisplay.

18. The HMD device of claim 17 wherein the input coupler is configured with the at least one polarization-sensitive reflector and the polarization-retarding waveplate comprises a half-wave plate.

19. The HMD device of claim 17 wherein the waveguide is configured with the at least one polarization-sensitive reflector and wherein the polarization-retarding waveplate comprises a quarter-wave plate.

20. The HMD device of claim 17 wherein the output coupler is configured with the at least one polarization-sensitive reflector and wherein the polarization-retarding waveplate comprises a half-wave plate.
